(19) United States
(12) Patent Application Publication
(10) Pub. No.: US 2026/0361542 A1
(43) Pub. Date: Nov. 12, 2026

(54) PHYSICAL ARTIFICIAL INTELLIGENCE OPERATING SYSTEM

(71) Applicant: Dorian Cartwright, San Jose, CA (US)

(72) Inventor: Dorian Cartwright, San Jose, CA (US)

(21) Appl. No.: 19/711,880

(22) Filed: Jun. 17, 2026

Related U.S. Application Data
(63) Continuation-in-part of application No. 19/696,651, filed on Jun. 3, 2026.
(63) Continuation-in-part of application No. 19/638,074, filed on Apr. 2, 2026.
(60) Provisional application No. 64/070,361, filed on May 20, 2026.
(60) Provisional application No. 64/070,365, filed on May 20, 2026.

(51) Int. Cl. H04L 9/32; G06F 21/64

(52) U.S. Cl. CPC H04L 9/3213; G06F 21/64; H04L 9/3247

(57) ABSTRACT

A physical artificial intelligence operating system is logically interposed between a non-deterministic artificial intelligence system and actuator hardware of a physical artificial intelligence agent. A mission authorization plane converts a mission request into a governed mission object and issues a cryptographically signed mission authorization token encoding a mission scope. A deterministic governance kernel evaluates the mission authorization token and current state data through governance gates including ownership, identity, infrastructure, resource, environmental, health, validation, and policy gates. A runtime arbiter monitors changing runtime state and updates gate states. A release-token authority generates an actuation release token based on the mission authorization token and gate states. An actuator firewall intercepts actuator-directed commands before delivery to a motor driver and permits, blocks, derates, clips, shapes, or modulates the commands based on verification of the actuation release token. A permission graph records mission, token, credential, validation, telemetry, and physical-action relationships.

### CROSS-REFERENCE TO RELATED APPLICATIONS

This application is a continuation-in-part of U.S. patent application Ser. No. 19/638,074, filed Apr. 2, 2026, entitled “PREDICTIVE ACTUATION GATING IN PHYSICAL ARTIFICIAL INTELLIGENCE,” by Dorian Cartwright, the entire contents of which are incorporated herein by reference.

This application claims priority under 35 U.S.C. §119(e) to U.S. Provisional Patent Application 64/070,361 filed May 20, 2026, entitled “HARDWARE-ENFORCED VALIDATED ACTUATION FOR AUTONOMOUS PHYSICAL ARTIFICIAL INTELLIGENCE SYSTEMS,” by Dorian Cartwright, the entire contents of which are incorporated herein by reference.

This application claims priority under 35 U.S.C. §119(e) to U.S. Provisional Patent Application No. 64/070,365 filed May 20, 2026, entitled “PROTECTED PHYSICAL ARTIFICIAL INTELLIGENCE ACTUATOR FIREWALL OPERATING SYSTEM,” by Dorian Cartwright, the entire contents of which are incorporated herein by reference.

This application is a continuation-in-part of U.S. patent application Ser. No. 19/696,651 filed Jun. 3, 2026, entitled “OWNERSHIP-GATED MISSION AUTHORIZATION AND CUSTODY CONTROL FOR MOBILE PHYSICAL ARTIFICIAL INTELLIGENCE AGENTS,” by Dorian Cartwright, the entire contents of which are incorporated herein by reference.

This application is related to U.S. patent application Ser. No. 19/640,711 filed Apr. 6, 2026, entitled “PREDICTIVE ACTUATION GATING FOR A HETEROGENEOUS PHYSICAL ARTIFICIAL INTELLIGENCE SWARM,” by Dorian Cartwright, the entire contents of which are incorporated herein by reference.

This application is related to U.S. patent application Ser. No. 19/640,766 filed Apr. 6, 2026, entitled “HARDWARE-GATED CROSS-SYSTEM CHARGING ARBITRATION FOR HETEROGENEOUS PHYSICAL ARTIFICIAL INTELLIGENCE SWARMS,” by Dorian Cartwright, the entire contents of which are incorporated herein by reference.

This application is related to U.S. patent application Ser. No. 19/654,785 filed Apr. 22, 2026, entitled “DECENTRALIZED STORAGE-SLOT RESERVATION IN A HETEROGENEOUS PHYSICAL ARTIFICIAL INTELLIGENCE (AI) SWARM,” by Dorian Cartwright, the entire contents of which are incorporated herein by reference.

This application is related to U.S. patent application Ser. No. 19/654,952 filed Apr. 22, 2026, entitled “DECENTRALIZED ENCOUNTER-BASED SHARING OF SEMANTIC HAZARD DATA IN A HETEROGENEOUS PHYSICAL ARTIFICIAL INTELLIGENCE (AI) SWARM,” by Dorian Cartwright, the entire contents of which are incorporated herein by reference.

This application is related to U.S. patent application Ser. No. 19/654,808 filed Apr. 22, 2026, entitled “DECENTRALIZED LOAD-SHARING AND POSITIONAL COORDINATION IN A HETEROGENEOUS PHYSICAL ARTIFICIAL INTELLIGENCE (AI) SWARM,” by Dorian Cartwright, the entire contents of which are incorporated herein by reference.

### FIELD OF THE INVENTION

The present disclosure relates generally to computers and artificial intelligence, and more specifically, to a physical artificial intelligence operating system that governs mission authorization, ownership, identity, infrastructure access, resource sufficiency, health state, predictive validation, and actuator-level release of physical actions generated by non-deterministic artificial intelligence systems.

### BACKGROUND

Physical artificial intelligence systems increasingly use vision-language-action models, large language model planners, robot foundation models, learned locomotion policies, reinforcement learning systems, and other probabilistic or non-deterministic artificial intelligence systems to generate missions, trajectories, tool calls, manipulation plans, navigation plans, and actuator-directed commands.

Conventional robot software stacks and middleware systems provide communication, device abstraction, process execution, and hardware interfaces, but they generally do not provide a deterministic Operating System kernel that treats physical action as a permissioned resource. As a result, a high-level artificial intelligence model may propose or generate a physical action that is unsafe, unauthorized, under-resourced, inconsistent with a robot role, outside a jurisdictional or infrastructure permission, inconsistent with ownership or custody status, or unsupported by current actuator health.

Existing safety mechanisms such as emergency stops, collision avoidance, driver limits, and geofences are often reactive, local, or hardware-specific. Existing fleet-management systems may assign tasks or routes, but they do not provide a local kernel-level governance layer that continuously determines whether an artificial intelligence-generated mission remains authorized and whether each actuator-directed command may be physically released.

There is therefore a need for a robust physical artificial intelligence operating system that is logically interposed between a non-deterministic intelligence layer and physical actuator hardware. There is further a need for a deterministic governance kernel that issues mission authorization tokens, evaluates governance gates, generates short-lived actuation release tokens, enforces actuator envelopes at hardware or firmware layers, monitors degraded capability states, supports multi-agent health and trust evaluation, and records a permission graph linking mission authorization, responsible parties, infrastructure grants, resource attestations, role credentials, validation results, actuator release tokens, telemetry, and physical actions.

### SUMMARY

Systems, methods, and computer program products are disclosed for a physical artificial intelligence operating system.

In one embodiment, a physical artificial intelligence operating system includes an intelligence interface, a mission authorization plane, a deterministic governance kernel, a runtime arbiter, an actuation control plane, a permission graph, and one or more hardware-enforced actuator interfaces. The intelligence interface receives a mission request, trajectory proposal, tool call, or physical action command generated by a non-deterministic artificial intelligence system, such as a vision-language-action model, large language model planner, robot foundation model, learned manipulation policy, or learned locomotion policy.

The mission authorization plane converts the request into a governed mission object and, upon satisfaction of one or more initial conditions, issues a mission authorization token. The mission authorization token may be cryptographically signed, time-bounded, scope-limited, and associated with a mission identifier, robot identifier, owner or custodian identifier, route or workspace, permitted roles, infrastructure grants, resource commitments, validation requirements, and permitted capability envelope.

The deterministic governance kernel evaluates the mission authorization token and current state inputs through a plurality of governance gates. The governance gates may include an ownership or custody gate, identity or role gate, infrastructure access gate, resource sufficiency gate, environmental or occupancy gate, multi-dimensional health gate, predictive validation gate, and policy or compliance gate.

The runtime arbiter continuously monitors robot state, owner or custody state, resource state, infrastructure state, role state, environmental state, agent health state, validation state, fleet integrity state, and actuator state. The runtime arbiter may trigger revalidation, mission suspension, degraded mission-scope reduction, mission transfer, fallback custody, or token revocation when a state change affects authorization.

The actuation control plane is configured to intercept actuator-directed commands before delivery to motor drivers or actuator controllers. In response to satisfaction of applicable governance conditions, the actuation control plane or a release-token authority generates an actuation release token. The actuation release token may be shorter-lived than the mission authorization token and may define an actuator scope, time window, force limit, torque limit, velocity limit, current limit, voltage limit, route segment, manipulation envelope, locomotion envelope, tool-use envelope, or revocation condition. The actuator firewall verifies the actuation release token and enforces the corresponding envelope by permitting, blocking, derating, clipping, shaping, or modulating an actuator-control signal.

In some embodiments, the physical artificial intelligence operating system maintains a permission graph or trust ledger that records relationships among mission requests, mission authorization tokens, owner or custodian credentials, infrastructure grants, resource attestations, role credentials, health states, validation outputs, actuation release tokens, actuator commands, telemetry, physical actions, peer attestations, and post-incident reconstruction records.

In some embodiments, the physical artificial intelligence operating system further includes a multi-dimensional health monitor comprising a cognitive health layer, physical health layer, energetic health layer, identity and compliance health layer, and connectivity and inference health layer. The health monitor may generate health vectors and a composite system health state used by the governance kernel and runtime arbiter.

In some embodiments, the physical artificial intelligence operating system further includes a collective fleet integrity module that receives health vectors from peer robots, detects peer disagreement, identifies common-cause failure patterns, performs consensus-weighted anomaly detection, and triggers coordinated hold states, mission transfers, or fleet-level safe modes.

Advantageously, the disclosed physical artificial intelligence operating system separates a non-deterministic inference plane from a deterministic governance and actuation-release plane, thereby improving safety, accountability, auditability, reliability, regulatory compliance, and hardware-enforced control of physical AI agents.

Many other variations are possible.

### BRIEF DESCRIPTION OF FIGURES

The present disclosure will be understood more fully from the detailed description given below and from the accompanying drawings of various embodiments of the disclosure.

FIG. 1 is a block diagram illustrating a physical artificial intelligence operating system logically interposed between a non-deterministic artificial intelligence layer and physical actuator hardware, according to an embodiment.

FIG. 2 is a block diagram illustrating a mission authorization plane that converts a mission request into a governed mission object and issues a mission authorization token, according to an embodiment.

FIG. 3 is a block diagram illustrating a deterministic governance kernel including ownership, identity, infrastructure, resource, environmental, health, validation, and policy gates, according to an embodiment.

FIG. 4 is a state diagram illustrating a mission authorization token lifecycle, according to an embodiment.

FIG. 5 is a block diagram illustrating an actuation control plane that generates and verifies actuation release tokens before actuator command execution, according to an embodiment.

FIG. 6 is a flow diagram illustrating capability-degraded mission scope reduction, according to an embodiment.

FIG. 7 is a block diagram illustrating a multi-dimensional health monitor, according to an embodiment.

FIG. 8 is a block diagram illustrating collective fleet integrity monitoring and peer disagreement arbitration, according to an embodiment.

FIG. 9 is a block diagram illustrating a permission graph or trust ledger, according to an embodiment.

FIG. 10 is a block diagram illustrating a computing environment for implementing the physical artificial intelligence operating system, according to an embodiment.

FIG. 11 illustrates an overall method for physical AI Operating System governance, according to an embodiment.

FIG. 12 illustrates a method for gate-based mission authorization, according to an embodiment.

FIG. 13 illustrates a method 1300 for capability-degraded actuation release, according to an embodiment.

### DETAILED DESCRIPTION

The description below provides systems, methods, and computer program products for a physical artificial intelligence operating system.

### I. Systems

### A. Physical AI Operating System Architecture

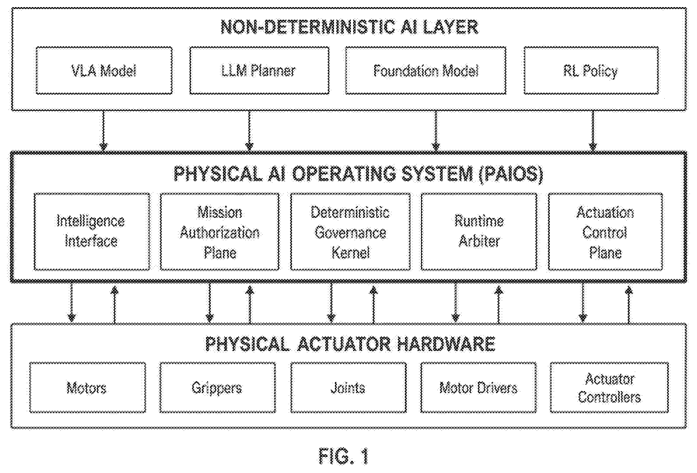

FIG. 1 illustrates a physical artificial intelligence operating system logically interposed between a non-deterministic artificial intelligence layer and physical actuator hardware, according to an embodiment. A physical artificial intelligence operating system may be implemented on a humanoid robot, mobile robot, quadruped robot, drone, autonomous vehicle, mobile manipulator, warehouse robot, surgical robot, service robot, construction robot, agricultural robot, industrial robot, or other embodied artificial intelligence system.

As shown in FIG. 1, the physical artificial intelligence operating system is positioned between an intelligence layer and physical hardware. The intelligence layer may include a vision-language-action model, large language model planner, robot foundation model, learned manipulation policy, learned locomotion policy, reinforcement learning policy, imitation learning policy, world model, human teleoperation interface, fleet-management planner, or other action-generating component.

The physical hardware of FIG. 1 may include motors, actuators, grippers, hands, arms, feet, legs, torso joints, head or gaze mechanisms, propulsion systems, brakes, tools, sensors, power systems, network interfaces, compute processors, motor drivers, and real-time controllers.

Unlike a conventional robot middleware fabric, the disclosed physical artificial intelligence operating system treats real-world physical action as a governed Operating System resource. A proposed mission or action is not permitted merely because an artificial intelligence model generated it or because a user authenticated to a device. Instead, the operating system determines whether the mission and action are authorized, resourced, credentialed, validated, healthy, compliant, and actuator-releasable.

### B. Intelligence Interface

Referring again to FIG. 1, the intelligence interface receives proposed missions, trajectories, action chunks, tool calls, manipulation commands, navigation commands, or actuator-directed commands from one or more intelligence sources.

The intelligence interface may normalize such requests into a mission request or action request. A mission request may include a natural-language instruction, parsed intent, task identifier, target object, target location, route, workspace, time window, expected human interaction, expected infrastructure interaction, expected resource demand, and risk class.

An action request may include an action type, actuator group, desired trajectory, desired force, desired torque, desired velocity, desired acceleration, tool state, object identity, contact state, environmental state, source model identifier, model confidence score, and command timestamp.

### C. Mission Authorization Plane

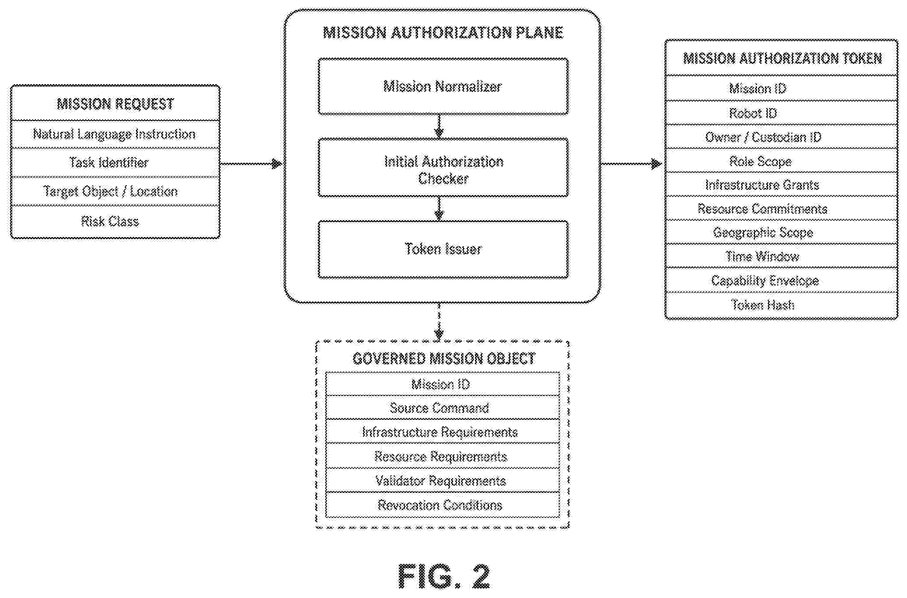

FIG. 2 illustrates a mission authorization plane that converts a mission request into a governed mission object and issues a mission authorization token, according to an embodiment. The mission authorization plane converts a mission request into a governed mission object. The governed mission object may include a mission identifier, robot identifier, source command, owner identifier, custodian identifier, operator identifier, mission class, route, workspace, infrastructure requirements, resource requirements, role requirements, policy requirements, validator requirements, audit requirements, fallback conditions, and revocation conditions.

As shown in FIG. 2, the mission authorization plane issues a mission authorization token when a mission satisfies initial authorization criteria. The mission authorization token may be a cryptographically signed data structure including a mission identifier, robot identifier, owner or custodian identifier, role scope, infrastructure grants, resource commitments, geographic scope, time window, expiration time, capability envelope, policy version, validator requirements, and hash of the governed mission object.

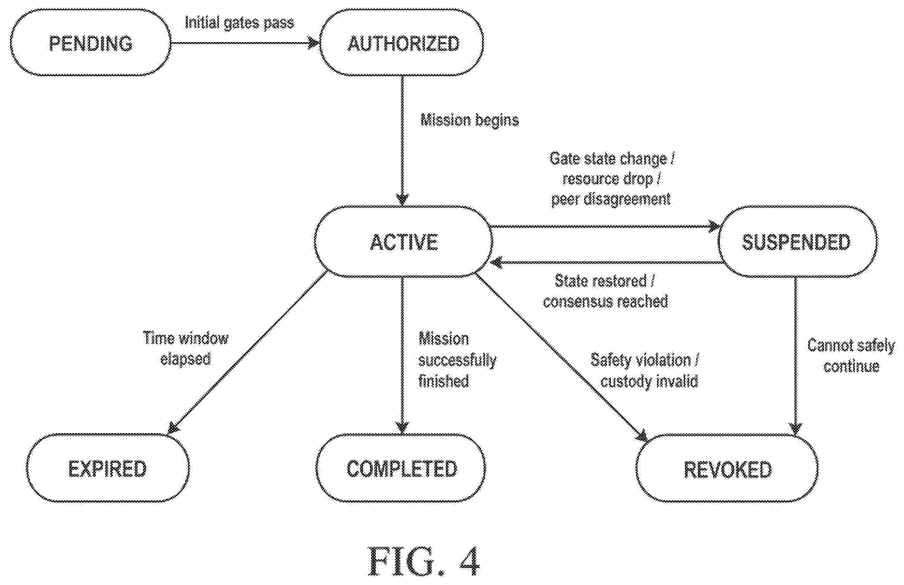

FIG. 4 illustrates a mission authorization token lifecycle, according to an embodiment. In some embodiments, the mission authorization token has a lifecycle including pending, authorized, active, suspended, revoked, expired, and completed. A token may transition from active to suspended when a governance gate changes state, when peer disagreement is detected, when an infrastructure grant is revoked, when resources become insufficient, when an owner becomes unreachable, or when actuator health degrades. A token may transition to revoked when the mission cannot safely continue.

### D. Deterministic Governance Kernel

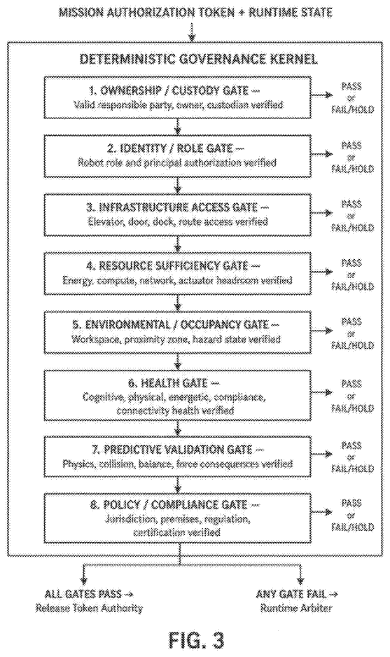

FIG. 3 illustrates a deterministic governance kernel including ownership, identity, infrastructure, resource, environmental, health, validation, and policy gates, according to an embodiment. The deterministic governance kernel evaluates the mission authorization token, governed mission object, proposed actions, and current runtime state.

As shown in FIG. 3, an ownership or custody gate verifies that the mission is associated with a valid responsible party, owner, custodian, operator, insurer, employer, municipal authority, fleet account, guardian, temporary steward, or other accountable entity.

An identity or role gate verifies that the robot or requesting principal is authorized to act in a role, such as courier, caregiver, security agent, employee, contractor, medical assistant, personal representative, delivery agent, service robot, emergency assistant, or infrastructure user.

An infrastructure access gate verifies required access to elevators, doors, chargers, docks, autonomous vehicles, premises, loading zones, sidewalks, buildings, municipal routes, restricted zones, tool stations, or other physical infrastructure.

A resource sufficiency gate evaluates energy, compute, memory, network, cloud inference availability, actuator headroom, maintenance state, tool availability, consumables, payment authority, account status, and time budget.

An environmental or occupancy gate evaluates whether a workspace, route, human-proximity zone, object-interaction zone, or shared region is clear or otherwise permissive for the proposed mission or action.

A multi-dimensional health gate evaluates cognitive health, physical health, energetic health, identity and compliance health, connectivity and inference health, and, in some embodiments, fleet-level integrity.

A predictive validation gate evaluates predicted consequences of one or more proposed actions using a deterministic safety envelope, physics model, reachability model, collision validator, tactile validator, force-contact validator, balance validator, semantic-hazard validator, shared-load validator, or world model.

A policy or compliance gate evaluates jurisdictional rules, premises rules, public-space rules, user rules, manufacturer policies, insurance constraints, certification conditions, service-level conditions, privacy policies, and regulatory reporting requirements.

### E. Runtime Arbiter

Referring to FIGS. 3 and 4, the runtime arbiter continuously monitors state during mission execution and may cause the mission authorization token lifecycle of FIG. 4 to transition between active, suspended, revoked, expired, or completed states. State inputs may include robot telemetry, actuator telemetry, sensor integrity, battery state, compute load, network quality, infrastructure-grant status, owner heartbeat, custodian heartbeat, role credential freshness, mission progress, environmental occupancy, peer-robot messages, fleet integrity state, and validator state.

When the runtime arbiter detects a change that affects authorization, it may cause one or more governance gates of FIG. 3 to be re-evaluated. The runtime arbiter may suspend a mission authorization token, revoke an actuation release token, reduce mission scope, reroute the mission, require human confirmation, trigger fallback custody, transfer a task to a peer robot, or terminate physical execution.

### F. Actuation Control Plane and Actuator Firewall

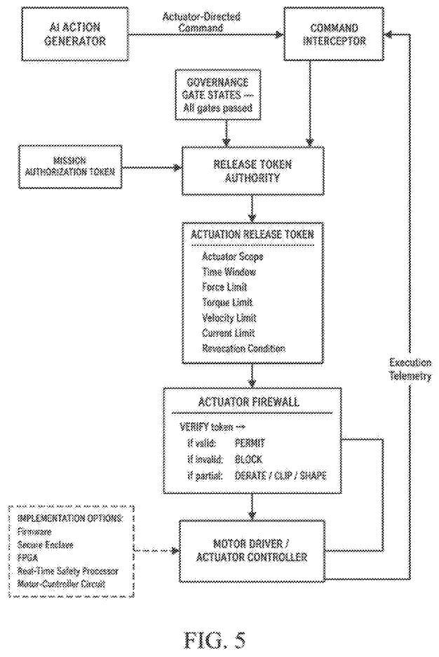

FIG. 5 illustrates an actuation control plane that generates and verifies actuation release tokens before actuator command execution, according to an embodiment. The actuation control plane is a hardware-proximate enforcement layer. It intercepts actuator-directed commands before such commands reach motor drivers, actuator drivers, firmware controllers, motor-controller circuits, brake controllers, gripper controllers, propulsion controllers, or tool controllers.

As shown in FIG. 5, the actuation control plane verifies whether the actuator-directed command is associated with a valid mission authorization token and a valid actuation release token. The actuation release token may be generated only after applicable governance gates have passed. In some embodiments, the actuation release token is extremely short-lived and represents the instantaneous authorization state for a command or command chunk.

The actuation control plane enforces the actuation release token by permitting, blocking, derating, clipping, shaping, rate-limiting, delaying, decomposing, or modulating the actuator-directed command. Enforcement may control joint torque, motor current, voltage, pulse-width modulation, velocity, acceleration, jerk, position, braking, gripper force, tool power, or locomotion gait parameters.

In some embodiments, the actuator firewall is implemented in firmware, a secure enclave, a trusted execution environment, a field-programmable gate array, a motor-controller circuit, a driver-board microcontroller, a real-time safety processor, or dedicated hardware logic physically interposed on a communication path between an inference compute unit and actuator driver hardware.

### G. Multi-Dimensional Health Monitor

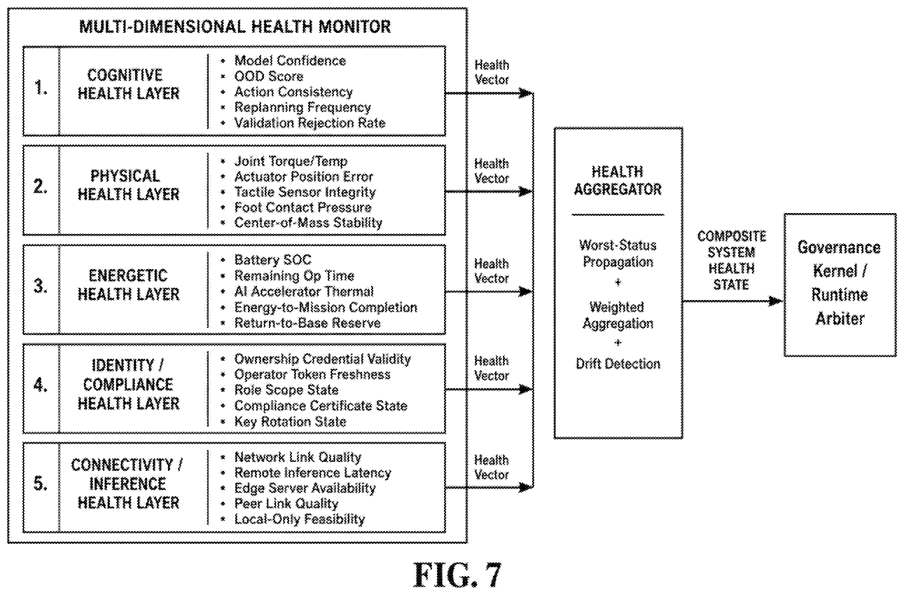

FIG. 7 illustrates a multi-dimensional health monitor, according to an embodiment. A multi-dimensional health monitor may generate health vectors for a physical AI platform. The health vectors may include cognitive health, physical health, energetic health, identity and compliance health, and connectivity and inference health.

The cognitive health layer of FIG. 7 may monitor model output confidence, uncertainty, out-of-distribution score, action consistency, hallucination risk, replanning frequency, validation rejection rate, and model version integrity.

The physical health layer of FIG. 7 may monitor joint torque, joint position error, actuator temperature, tactile sensor integrity, foot contact pressure, terrain traversability, structural vibration, sensor calibration, payload headroom, center-of-mass stability margin, and end-effector integrity.

The energetic health layer of FIG. 7 may monitor battery state-of-charge, battery health, remaining operational time, AI accelerator thermal state, peak current draw, energy required to complete a mission, return-to-base reserve, and per-subsystem power consumption.

The identity and compliance health layer of FIG. 7 may monitor ownership credential validity, operator authorization freshness, role-scope permission state, jurisdictional compliance certificate state, subscription entitlement state, cryptographic key rotation state, tamper state, and mission authorization freshness.

The connectivity and inference health layer of FIG. 7 may monitor local network quality, remote inference latency, edge-server availability, cloud endpoint availability, peer link quality, time synchronization, queue depth, and local-only operation feasibility.

The health monitor may use worst-status propagation, weighted aggregation, drift detection, baseline comparison, trend analysis, and self-diagnostic probing to generate a composite system health state.

### H. Capability-Degraded Mission Scope Reduction

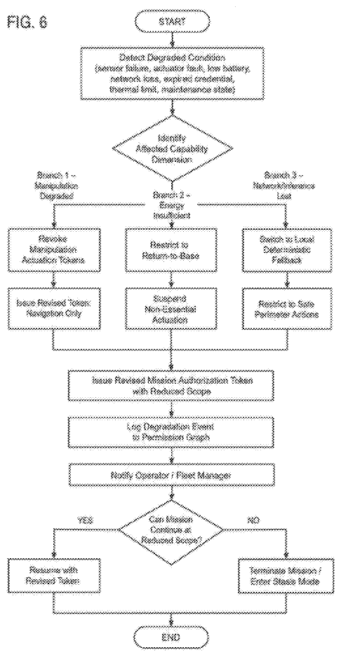

FIG. 6 illustrates capability-degraded mission scope reduction, according to an embodiment. When a degraded condition is detected, the physical artificial intelligence operating system may reduce mission scope rather than merely stopping.

As shown in FIG. 6, a degraded condition may include sensor failure, actuator fault, gripper degradation, locomotion instability, low battery, compute insufficiency, network loss, expired role credential, expired infrastructure grant, maintenance state, thermal limitation, or degraded model confidence.

For example, if a gripper is degraded, the robot may lose manipulation authorization but retain navigation authorization. If a remote model is unavailable, the robot may continue under local deterministic fallback control. If battery reserve falls below a threshold, the robot may be limited to return-to-base. If ownership or custody state becomes invalid, the robot may enter fallback custody or stasis mode.

The operating system may issue a revised mission authorization token or update an operating envelope to reflect reduced scope.

### I. Collective Fleet Integrity and Peer Disagreement

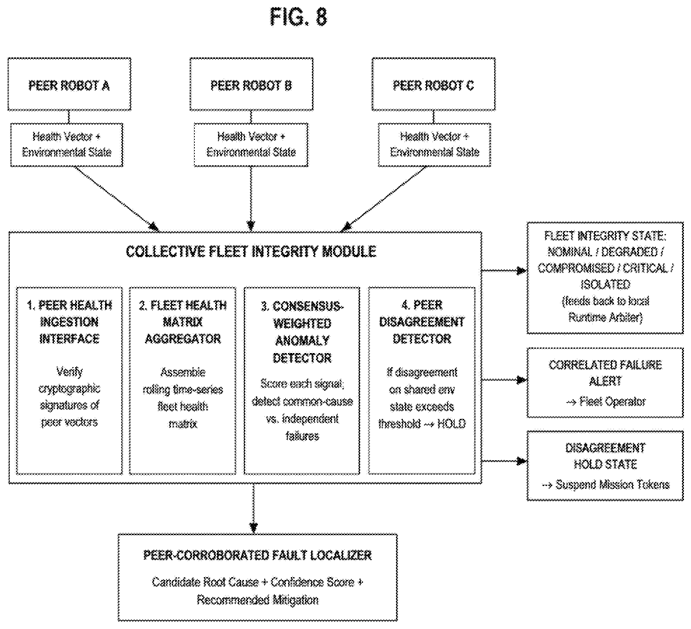

FIG. 8 illustrates collective fleet integrity monitoring and peer disagreement arbitration, according to an embodiment. In some embodiments, the operating system receives health vectors, environmental estimates, occupancy states, or trust attestations from peer robots. A collective fleet integrity module may detect correlated degradation, common-cause failure, peer disagreement, spoofed telemetry, or fleet-wide compromise.

As shown in FIG. 8, if two or more robots disagree on a shared environmental state beyond a threshold, the operating system may enter a peer disagreement hold state. During the hold state, one or more robots suspend mission tokens or block actuation release tokens pending resynchronization, consensus, external sensor confirmation, or human arbitration.

A robot-to-robot handoff may be performed when a primary robot becomes degraded or lacks resources. A derivative mission token or sub-token may be transferred to a second robot, and the second robot executes the mission only if its own governance gates validate the transferred mission scope.

### J. Permission Graph and Trust Ledger

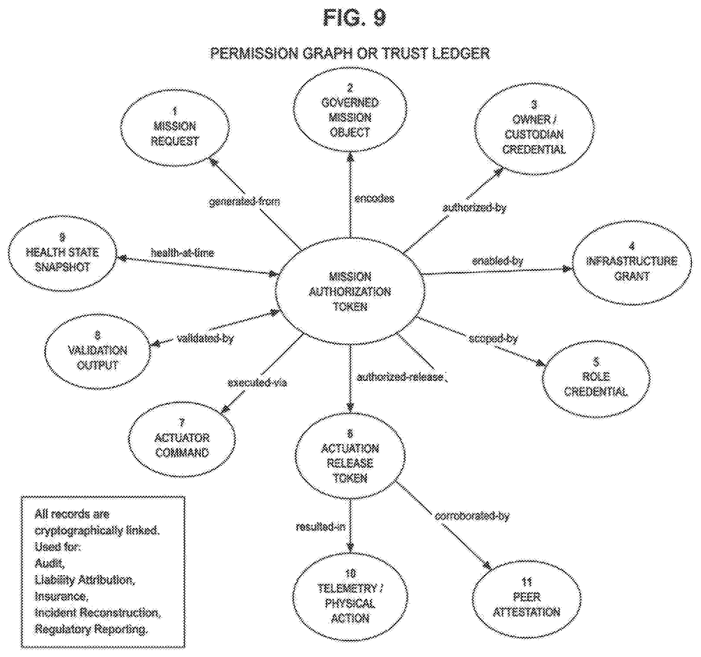

FIG. 9 illustrates a permission graph or trust ledger, according to an embodiment. The permission graph stores cryptographically linked records of mission requests, governed mission objects, mission authorization tokens, owner credentials, custodian credentials, infrastructure grants, resource attestations, role credentials, health vectors, validation outputs, actuation release tokens, actuator commands, telemetry, peer attestations, trust scores, and physical actions.

The permission graph of FIG. 9 may be used for audit, insurance, liability attribution, incident reconstruction, regulatory reporting, policy refinement, fleet trust scoring, and post-incident behavioral attestation.

### K. Computing Environment

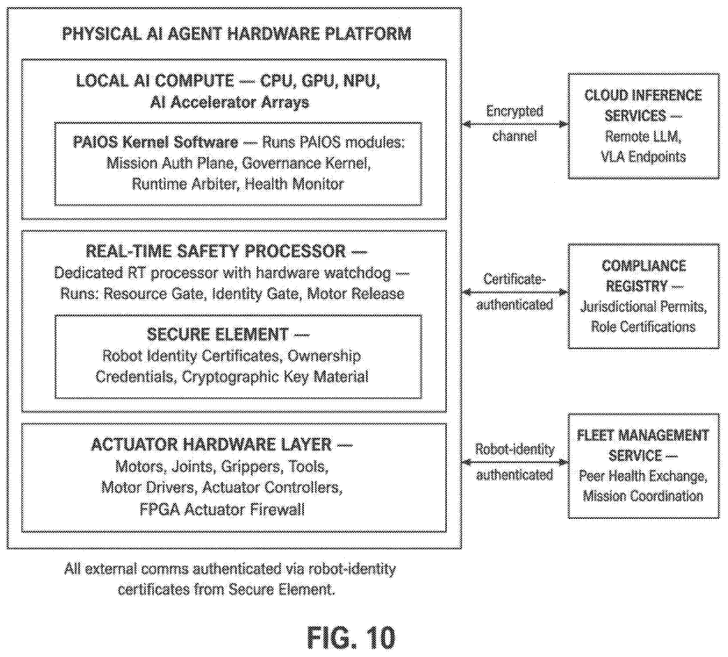

FIG. 10 illustrates a computing environment for implementing the physical artificial intelligence operating system, according to an embodiment. The computing environment may include one or more processors, memory, storage, communications interfaces, input/output interfaces, local robot controllers, edge computing resources, cloud services, infrastructure controllers, fleet servers, secure enclaves, trusted execution environments, real-time safety processors, motor-controller circuits, or combinations thereof.

The computing environment of FIG. 10 may execute one or more components of the physical artificial intelligence operating system, including the intelligence interface, mission authorization plane, deterministic governance kernel, runtime arbiter, actuation control plane, multi-dimensional health monitor, collective fleet integrity module, permission graph, and associated policy engines.

The computing environment of FIG. 10 may be distributed across a robot, edge server, cloud platform, infrastructure controller, fleet controller, municipal system, building system, or peer robot network. In some embodiments, time-sensitive enforcement functions execute locally or at actuator-proximate hardware, while longer-horizon validation, audit, policy update, model update, or fleet-integrity functions execute at an edge or cloud layer.

### II. Methods

The methods can be computer-implemented methods or computer program products performing a method, while deployed by the components of FIG. 1 or other systems. There can be fewer or additional steps, in different orders, with varying groups of functionality.

### A. Overall Method for Physical AI Operating System Governance

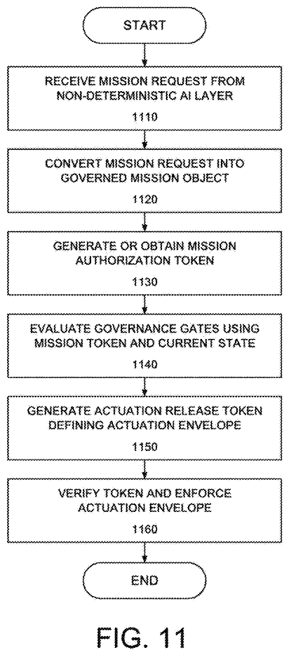

FIG. 11 illustrates an overall method 1100 for physical AI operating system governance.

At 1110, a physical artificial intelligence operating system receives a mission request from a non-deterministic artificial intelligence layer. The mission request may include a natural-language instruction, planner-generated task, trajectory proposal, tool-use request, or other AI-generated command for physical operation of a robot.

At 1120, the physical artificial intelligence operating system converts the mission request into a governed mission object including mission scope, robot role, required resources, infrastructure dependencies, and actuation constraints. The governed mission object provides a structured representation that can be evaluated by deterministic governance components before physical execution is permitted.

At 1130, the physical artificial intelligence operating system generates or obtains a mission authorization token corresponding to the governed mission object. The mission authorization token may encode mission scope, robot identity, owner or custodian identity, role authority, infrastructure grants, resource commitments, policy version, and temporal validity.

At 1140, a deterministic governance kernel evaluates a plurality of governance gates using the mission authorization token and current robot state data. The governance gates may include ownership, identity, infrastructure, resource, environmental, health, validation, and policy gates that collectively determine whether the mission remains authorized.

At 1150, responsive to satisfaction of the governance gates, the physical artificial intelligence operating system generates an actuation release token defining an actuation envelope. The actuation release token may be shorter-lived than the mission authorization token and may specify actuator scope, force limits, torque limits, velocity limits, time window, route segment, manipulation envelope, locomotion envelope, or revocation conditions.

At 1160, an actuator firewall verifies the actuation release token and enforces the actuation envelope at or near actuator hardware. Enforcement may include permitting, blocking, derating, clipping, shaping, or modulating actuator-control signals before such signals reach a motor driver, actuator controller, firmware controller, or driver-board circuit.

### B. Method for Gate-Based Mission Authorization

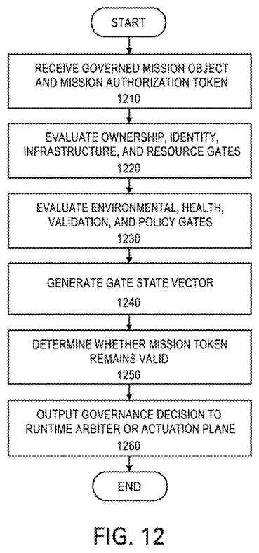

FIG. 12 illustrates a method 1200 for gate-based mission authorization, as an Example of Step 1140 of FIG. 11.

At 1210, the deterministic governance kernel receives the governed mission object and the mission authorization token. The deterministic governance kernel may extract mission scope, role authority, infrastructure requirements, resource commitments, policy identifiers, and expiration data for gate-level evaluation.

At 1220, the deterministic governance kernel evaluates an ownership gate, an identity or role gate, an infrastructure gate, and a resource gate. These gates determine whether a responsible party exists, whether the robot has authority to act in the requested role, whether required infrastructure access is available, and whether required resources are sufficient.

At 1230, the deterministic governance kernel evaluates one or more environmental, robot-health, validation, or policy gates using runtime state data. These gates may account for occupancy state, human proximity, sensor or actuator health, predictive validation results, jurisdictional rules, premises rules, or other runtime constraints.

At 1240, the deterministic governance kernel generates a gate state vector indicating satisfied, unsatisfied, degraded, suspended, or revoked gate conditions. The gate state vector provides a machine-readable representation of the current authorization state of the mission across multiple governance dimensions.

At 1250, the deterministic governance kernel determines whether the mission authorization token remains valid, should be revised, should be suspended, or should be revoked. This determination may be based on the gate state vector, token expiration, changed resource conditions, changed infrastructure conditions, degraded robot capability, or policy violation.

At 1260, the deterministic governance kernel outputs a governance decision to a runtime arbiter or actuation control plane. The governance decision may authorize continued operation, require revalidation, reduce mission scope, suspend mission execution, revoke authorization, or permit actuation-token generation.

### C. Method for Capability-Degraded Actuation Release

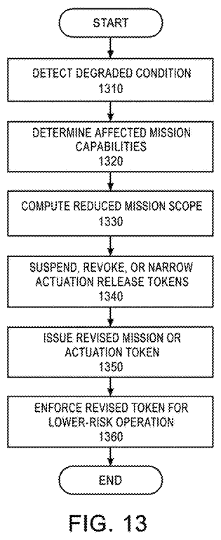

FIG. 13 illustrates a method 1300 for capability-degraded actuation release, as an example of step 1150 or step 1160 of FIG. 11.

At 1310, a health monitor detects a degraded condition associated with a robot capability, resource, actuator, sensor, network connection, thermal state, power state, or infrastructure dependency. The degraded condition may indicate that the mission remains partially executable but that one or more capabilities should no longer be authorized.

At 1320, the physical artificial intelligence operating system determines one or more mission capabilities affected by the degraded condition. For example, a degraded gripper may affect manipulation authority, a degraded foot sensor may affect locomotion authority, and a network failure may affect cloud-dependent inference authority.

At 1330, the physical artificial intelligence operating system computes a reduced mission scope that removes, modifies, derates, or reorders one or more mission tasks. The reduced mission scope may permit lower-risk navigation, return-to-base behavior, waiting behavior, signaling behavior, or custody-transfer behavior while prohibiting higher-risk manipulation or travel.

At 1340, the physical artificial intelligence operating system suspends, revokes, or narrows one or more actuation release tokens associated with the affected mission capabilities. The narrowed actuation release token may remove an actuator group, reduce force or torque limits, shorten a time window, restrict a route segment, or impose a conservative fallback envelope.

At 1350, the physical artificial intelligence operating system issues a revised mission authorization token or revised actuation release token corresponding to the reduced mission scope. The revised token allows the physical AI agent to continue only within the updated authorization envelope.

At 1360, the actuator firewall enforces the revised token by permitting lower-risk operation while prohibiting higher-risk operation outside the reduced mission scope. Enforcement may occur by blocking commands to affected actuators, derating actuator-control signals, limiting locomotion speed, disabling manipulation, or routing the robot to a fallback state.

### III. Generalities

The disclosed systems may be implemented in software, firmware, hardware, or combinations thereof. Components may execute locally on a robot, on an edge server, in a cloud service, in an infrastructure controller, in a fleet server, or in a distributed architecture.

I claim:

1. A physical artificial intelligence operating system comprising:
an intelligence interface configured to receive a mission request generated by a non-deterministic artificial intelligence system for a physical artificial intelligence agent;
a mission authorization plane configured to convert the mission request into a governed mission object and issue a cryptographically signed mission authorization token encoding a mission scope;
a deterministic governance kernel logically interposed between the non-deterministic artificial intelligence system and physical hardware of the physical artificial intelligence agent, the deterministic governance kernel comprising a plurality of governance gates configured to evaluate the mission authorization token and current state data;
a runtime arbiter configured to continuously monitor runtime state data and update one or more gate states of the plurality of governance gates;
an actuation control plane comprising an actuator firewall configured to intercept actuator-directed commands before delivery to a motor driver; and
a release-token authority configured to generate an actuation release token based on the mission authorization token and the one or more gate states, wherein the actuator firewall is configured to permit, block, derate, clip, shape, or modulate an actuator-directed command based on verification of the actuation release token.

2. The system of claim 1, wherein the non-deterministic artificial intelligence system comprises a vision-language-action model, large language model planner, robot foundation model, learned locomotion policy, learned manipulation policy, or reinforcement learning policy.

3. The system of claim 1, wherein the plurality of governance gates comprises an ownership or custody gate, identity or role gate, infrastructure access gate, resource sufficiency gate, environmental or occupancy gate, health gate, predictive validation gate, and policy or compliance gate.

4. The system of claim 1, wherein the mission authorization token includes a mission identifier, robot identifier, owner or custodian identifier, role scope, infrastructure grant, resource commitment, geographic scope, time window, policy version, capability envelope, and hash of the governed mission object.

5. The system of claim 1, wherein the actuation release token is shorter-lived than the mission authorization token and defines at least one of actuator scope, time window, force limit, torque limit, velocity limit, acceleration limit, current limit, voltage limit, manipulation envelope, locomotion envelope, or revocation condition.

6. The system of claim 1, wherein the actuator firewall is implemented in firmware, a secure enclave, a trusted execution environment, a field-programmable gate array, a real-time safety processor, a motor-controller circuit, or a driver-board microcontroller.

7. The system of claim 1, wherein modulating the actuator-directed command comprises controlling at least one of joint torque, motor current, voltage, pulse-width modulation, velocity, acceleration, jerk, gripper force, tool power, or braking.

8. The system of claim 1, further comprising a multi-dimensional health monitor configured to generate a composite health state from a cognitive health layer, physical health layer, energetic health layer, identity and compliance health layer, and connectivity and inference health layer.

9. The system of claim 8, wherein the health gate is configured to modify a gate state based on the composite health state.

10. The system of claim 1, wherein the runtime arbiter is configured to detect a degraded condition and reduce the mission scope while permitting at least one lower-risk action to continue.

11. The system of claim 10, wherein the degraded condition comprises actuator failure, sensor failure, gripper degradation, locomotion instability, compute insufficiency, energy insufficiency, network loss, expired credential, infrastructure denial, thermal limitation, or maintenance fault.

12. The system of claim 1, further comprising a permission graph configured to store cryptographically linked records of mission requests, governed mission objects, mission authorization tokens, owner credentials, infrastructure grants, resource attestations, role credentials, health states, validation outputs, actuation release tokens, telemetry, and physical actions.

13. The system of claim 12, wherein the permission graph is used for audit, insurance, incident reconstruction, trust scoring, liability attribution, regulatory reporting, or post-incident behavioral attestation.

14. The system of claim 1, further comprising a collective fleet integrity module configured to receive health vectors or environmental state estimates from peer physical artificial intelligence agents and detect peer disagreement or correlated degradation.

15. The system of claim 14, wherein detecting peer disagreement causes one or more mission authorization tokens to transition to a suspended state pending resynchronization, consensus, external sensor confirmation, or human arbitration.

16. A computer-implemented method comprising:
receiving, by a physical artificial intelligence operating system, a mission request generated by a non-deterministic artificial intelligence model for a physical artificial intelligence agent;
converting the mission request into a governed mission object;
issuing a cryptographically signed mission authorization token encoding a mission scope of the governed mission object;
evaluating the mission authorization token and current state data through a plurality of governance gates of a deterministic governance kernel;
monitoring runtime state data and updating one or more gate states of the plurality of governance gates;
generating an actuation release token based on the mission authorization token and the one or more gate states;
intercepting an actuator-directed command before delivery to a motor driver; and
permitting, blocking, derating, clipping, shaping, or modulating the actuator-directed command based on verification of the actuation release token.

17. The method of claim 16, further comprising detecting a degraded condition and reducing the mission scope without fully terminating operation of the physical artificial intelligence agent.

18. The method of claim 16, further comprising storing, in a permission graph, a cryptographically linked record associating the actuator-directed command with the mission authorization token, the actuation release token, at least one governance gate status, and telemetry data.

19. The method of claim 16, further comprising receiving peer state data from a peer physical artificial intelligence agent, detecting disagreement between the physical artificial intelligence agent and the peer physical artificial intelligence agent, and placing the physical artificial intelligence agent into a hold state.

20. A non-transitory computer-readable medium storing instructions that, when executed by one or more processors, cause the one or more processors to:
receive a mission request generated by a non-deterministic artificial intelligence system;
generate a governed mission object;
issue a cryptographically signed mission authorization token encoding a mission scope;
evaluate the mission authorization token and current state data using a deterministic governance kernel comprising ownership, identity, infrastructure, resource, environmental, health, validation, and policy gates;
generate an actuation release token based on gate states of the deterministic governance kernel;
intercept an actuator-directed command before delivery to actuator hardware; and
physically enforce the actuator-directed command by permitting, blocking, derating, clipping, shaping, or modulating an actuator-control signal based on verification of the actuation release token.
